(19) United States
(12) Patent Application Publication
(10) Pub. No.: US 2009/0081895 A1
(43) Pub. Date: Mar. 26, 2009

(54) UNIVERSAL ADAPTER

(76) Inventors: Anthony Lee, Taipei (TW); Jeng-Je Pan, Taipei City (TW)

Correspondence Address: Dykema Gossett, PLLC, Suite 300 West, 1300 I Street, N.W., Washington, DC, 20005-3306, US

(21) Appl. No.: 11/858,213

(22) Filed: Sep. 20, 2007

(51) Int. Cl. H01R 29/00

(52) U.S. Cl. 439/173

(57) ABSTRACT

The universal adapter of the present invention comprises an adapter body having at least one set of power sockets, a power plug and a conductive unit, wherein the power plug has a fixed unit and a rotating unit that is located both ends of the fixed unit inside the adapter body. Each side of the fixed unit comprises male connectors, in which one end of every male connector is assembled with the rotating unit, and another end of every male connector can be protruded through the adapter body. The conductive unit comprises sets of connecting sockets that are corresponding to the set of power sockets, and a set of conductive flat pieces protruded from one end of the sets of connecting sockets, is in contact with the rotating units. The universal adapter is used as a travel adapter that it allows the user to plug their electrical appliances to various power plug standards by changing different male connectors.

### BACKGROUND OF THE INVENTION

1. Field of Invention

The present invention relates to a universal adapter, more particularly, the present invention relates to an improved universal adapter that can be plugged into different types of plug sets by changing the male connectors of the universal adapter.

2. Description of the Related Art

Refer to FIG. 1, the conventional adapter comprises a first plug set 4 and a second plug set 5, wherein the first plug set 4 comprises the first power plug (male connectors) 41 which can have different types of male connectors in accordance with various plug standards in different countries. On the other side of the first plug set 4 comprises the first plug sockets 42. The second plug set 5 comprises a set of second power plug (male connectors) 51 that are corresponding to the power sockets 42 of the first plug set 4, and a set of power sockets 52 that can be used for the user's electrical appliance. From FIG. 1, when the user wants to use the adapter for connecting to the power source with various types of plug sets in different countries, the user needs to choose the suitable male connectors 41 of the plug on the first plug set 4. Once the desired male connectors 41 of the first plug set 4 is selected, the second set of male connectors 51 of the second plug set 5 are plugged into the first power sockets 42 of the first plug set 4 so that the electrical appliance is plugged into the power sockets 52 of the second plug set 5 to electrically connect to the electrical appliance to the power source.

Although the conventional plugs comprise several types of male connectors (power plugs) 41 and the second plug set 5 to connect to the power source, but the user is required to bring all different types of plug sets 4 when he travels overseas. This kind of conventional travel adapter is not convenient to carry around, further if one of plug sets 4 is missing, the user may not be able to plug in at certain countries. Moreover, the fabrication of plug sets 4 with different male connectors 41 according to various countries' standards can result high production costs. Since the user is required to carry at least two sets of plug sets 4 & 5 or more sets of plugs to various places for connecting to the power source, therefore, the conventional adapter is very inconvenient to travel with.

### SUMMARY OF THE INVENTION

It is an objective of the present invention to provide a universal adapter that can improve the utilization of the adapters to different types of plug sets.

It is another objective of the present invention to provide an improved universal adapter that can overcome all the disadvantages of the conventional adapters.

The universal adapter of the present invention comprises an adapter body having at least one set of power sockets, a power plug, a conductive unit and conductive bars, wherein the power plug has a fixed unit and a rotating unit that is located both ends of the fixed unit inside the adapter body. Each side of the fixed unit comprises male connectors, in which one end of every male connector is assembled with the rotating unit, and another end of every male connector is protruded through the adapter body.

The conductive unit comprises sets of connecting sockets that are corresponding to the set of power sockets, and a set of conductive flat pieces protruded from one end of the sets of connecting sockets, is in contact with the rotating units. The adapter body has at least one conductive bar therein, which is integrated with one corresponding sleeve on the bottom cover, and a connection between the conductive bar and the corresponding sleeve is designed in such a way that the bottom cover is disintegrated from the adapter body to a predetermined distance without disassembling completely from the adapter body.

The universal adapter is used as a travel adapter that it allows the user to plug their electrical appliances to various power plug standards by changing different male connectors of the universal adapter.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the invention. In the drawings,

FIG. 1 shows 3-D views of various conventional adapters;

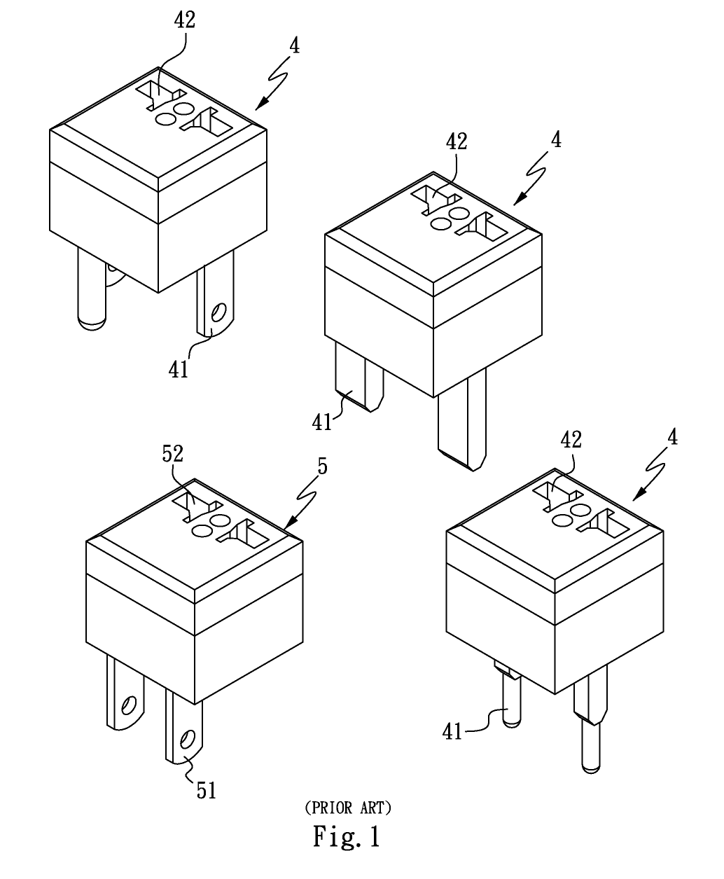

FIG. 2 shows an assembly view of a universal adapter in accordance with a preferred example of the present invention;

FIG. 3 shows a 3-D view of an assembled universal adapter in accordance with the preferred example of the present invention respectively;

FIG. 4 is a schematic cross-sectional view of an assembled universal adapter;

FIG. 5 is a schematic 3-D view of changing different male connectors 23 of an assembled universal adapter in accordance with a preferred example of the present invention.

### DESCRIPTION OF THE PREFERRED EMBODIMENTS

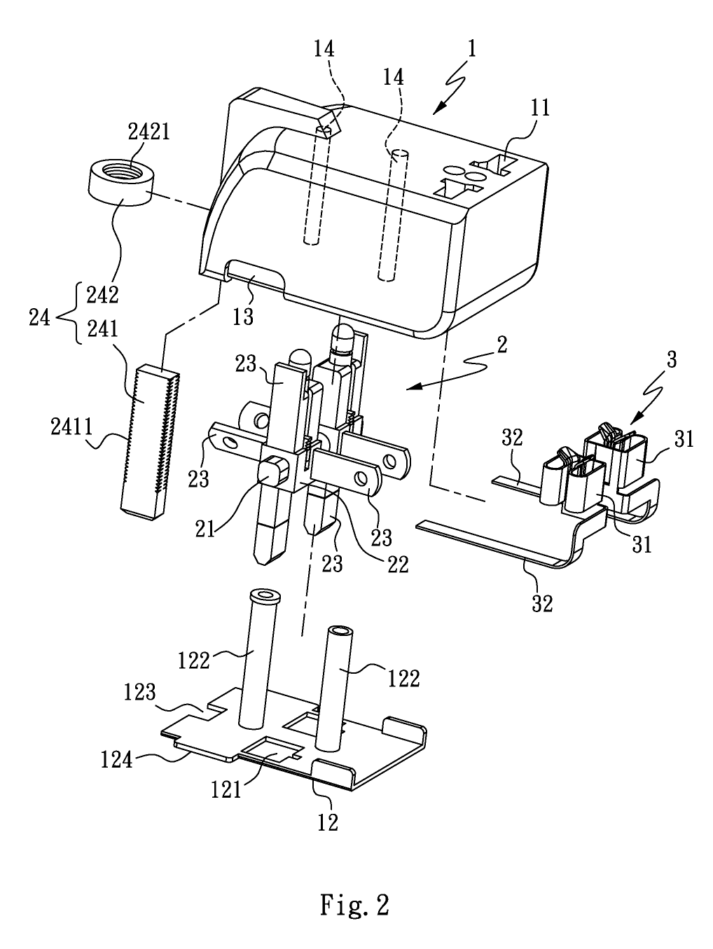

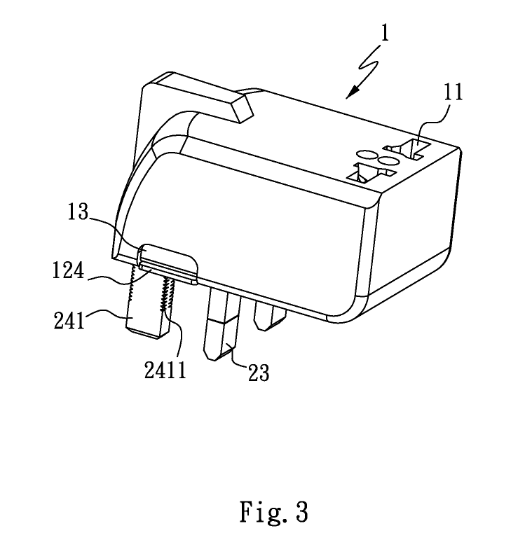

Refer to FIGS. 2 and 3, an assembly view of a universal adapter and a 3-D view of an assembled universal adapter in accordance with a preferred example of the present invention respectively.

A universal adapter of the present invention comprises an adapter body 1, a power plug 2 and a conductive unit 3. The power plug 2 of the universal adapter can be utilized and connected to different kinds of sockets, and it is designed to be carried easily. The universal adapter of the present invention is also designed to allow the users to plug in their appliance to any plug in different countries wherever they travel.

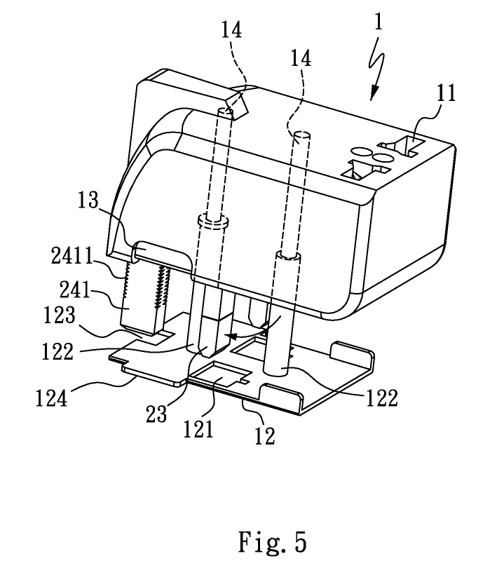

The adapter body 1 of the universal adapter comprises a set of power sockets 11 on a top part of the adapter body 1 and two conductive bars 14 inside the adapter body 1 as shown in FIG. 2, wherein the set of the power sockets 11 is a universal receptacle which can be applied to various types of power plugs. A bottom cover 12 comprises a plurality of holes 121. A set of sleeves 122, which is positioned on an inner section of the bottom cover 12 as shown in FIG. 2 is integrated with the corresponding conductive bars 14 of the adapter body 1. When the set of sleeves 122 is integrated with the adapter body 1, the integrated structure of the sleeves 122 and the adapter body 1 is movable and flexible. In other words, once the universal adapter is assembled, the set of sleeves 122 of the bottom cover 12 can be moved away from the adapter body 1 to a predetermined distance without disintegrating from the adapter body 1 as shown in FIG. 5. A trench 123 is located at one side of the bottom cover 12, and the adapter body 1 and the bottom cover 12 comprise a connecting part 13 and a corresponding part 124 respectively.

The power plug 2 comprises at least one rotating unit 21 positioned on the adapter body 1 (a plurality of rotating units 21 can be provided on in the power plug 2). The power plug 2 further comprises a fixed unit 22, wherein both ends of the fixed unit 22 comprise the rotating unit 21. A plurality of male connectors 23 is located on the sides of the fixed unit 22, wherein the male connectors 23 include various types of connectors in order to fit into different types of power receptacles. One end of every male connector 23 is assembled with the rotating unit 21, wherein another end of each male connector 23 of the adapter body 1 can be protruded through the holes 121 of the bottom cover 12. The holes 121 of the bottom cover 12 are utilized to position the fixed unit 22. The rotating units 21 of the power plug 2 and every male connector 23 are made from conductive materials. A sliding unit 24 is provided at one side of the adapter body 1. The sliding unit 24 comprises a sliding shaft 241 and a rotating ring 242, wherein the sliding shaft 241 is corresponding to the trench 123 of the bottom cover 12 and the rotating ring 242 is partially exposed outside the adapter body 1. The sliding shaft 241 integrated to the rotating ring 242 to control the lifting and dropping movement of the sliding unit 24. Male screw pattern 2411 is provided on the sliding shaft 241 externally, and female screw pattern 2421 is provided on the rotating ring 242 internally. The male screw pattern 2144 of the sliding shaft 241 is screwed into the female screw pattern 2421 of the rotating ring 242.

The conductive unit 3 is installed within the adapter body 1, wherein sets of connecting sockets 31 provided on the conductive unit 3 are corresponding to the set of power sockets 11. A set of conductive flat pieces 32, which is protruded from one end of the sets of connecting sockets 31, is in contact with the rotating units 21 during the integration.

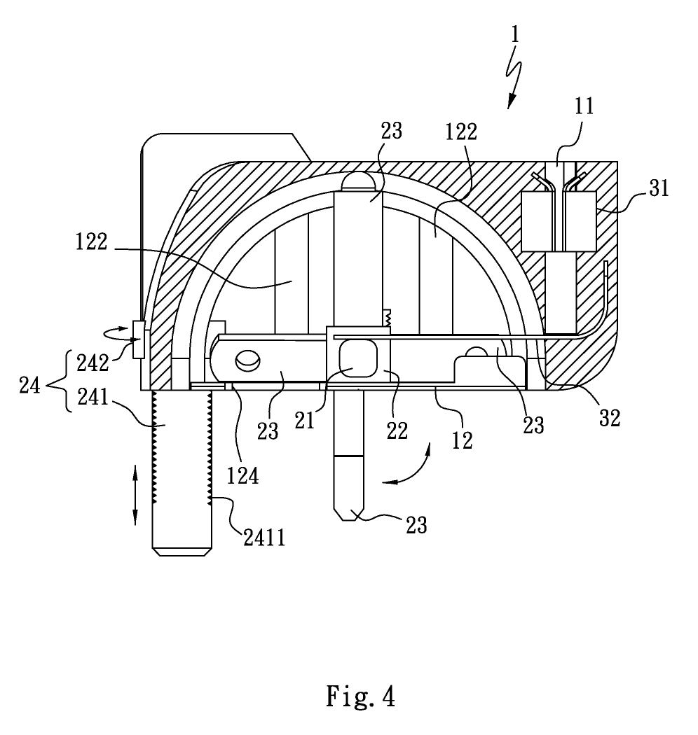

FIGS. 4 and 5, a schematic cross-sectional view of the assembled universal adapter, and a schematic 3-D view of changing different male connectors 23 of the assembled universal adapter in accordance with a preferred example of the present invention. The universal adapter of the present invention can be used as a travel adapter in which it allows the user to plug their electrical appliances to any plug in different countries with various power plug standards. The user can pull the bottom cover 12 downward as shown in FIG. 5, and the adapter body 1 utilizes its two conductive bars 14 positioned within the set of sleeves 122 to allow the bottom cover 12 dislocate from the adapter body 1 to a predetermined distance without disassembling completely from the adapter body 1. Once the adapter body is opened, the power plug 2 would be exposed, and the user can alter the male connectors 23 by rotating the male connectors 23 to trigger the rotating movement of the rotating units 21 on the fixed unit 22. The user can choose different types of male connectors 23 to plug the electrical appliance to various types of plugs around the world. Once the suitable male connectors 23 is chosen, the bottom cover 12 can be pushed upward to integrate the corresponding part 124 of the bottom cover 12 with the connecting part 13 of the adapter body 1. The selected male connectors 23 are exposed outside the bottom cover 12 through the holes 121. The design of the set of conductive flat pieces 32 of the conductive unit 3 is also to locate the position of the rotating units 21 within the holes 121 of the bottom cover 12. Once the desired male connectors 23 is selected and the bottom cover 12 is integrated back with the adapter body 1, the electrical power is transferred from the power plug 2 to the conductive unit 3, and the plug of the electrical appliance (not shown in the drawings) can be plugged into the set of the power socket 11 (universal receptacle) of the adapter body 1, so that the power plug 2 and the conductive flat pieces 32 of the conductive unit 3 are electrically connected to each other. The electrical power can then transfer from the universal adapter to the electrical appliance.

The universal adapter of the present invention can be used at different countries with different plug standards, such as in Britain, most of the plug sets on the wall have movable covers on its power sockets (not shown) for safety purpose. The universal adapter of the present invention can also be utilized in such case. The rotating ring 242 of the sliding unit 24 is rotated in such that the sliding shaft 241 is protruded through the trench 123 of the bottom cover 12, in which the sliding shaft 241 will be longer than the male connectors 23 as shown in FIGS. 4 and 5. When the male connectors 23 of the universal adapter is going to be plugged into the power socket of the plug having movable covers, the sliding shaft 241 will firstly push open the movable cover on top power socket of the plug in such to trigger the rest of movable covers on the power sockets to be opened so that the male connectors 23 can be plugged into the power sockets of the plug. Therefore, the objectives of the universal adapter of the present invention are to overcome the utilization problems of the conventional plugs and it is also specifically designed as a travel universal adapter to be used in various types of plug sets in different countries by simply altering different types of male connectors.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A universal adapter, comprising
an adapter body, having at least one set of power sockets;
a power plug, having a fixed unit and one rotating unit that is located both ends of the fixed unit, wherein the power plug is installed inside the adapter body, and each side of the fixed unit comprises male connectors, in which one end of the male connector is protruded through the adapter body; and
a conductive unit, located inside the adapter body, wherein the conductive unit comprises sets of connecting sockets that are corresponding to the set of power sockets, and a set of conductive flat pieces, which is protruded from one end of the sets of connecting sockets, is in contact with the rotating units, wherein the power plug is located inside the adapter body via a connection between the rotating unit and the conductive flat pieces.

2. The universal adapter of claim 1, wherein the adapter body further comprises a bottom cover having holes that are utilized to locate a position of the fixed unit.

3. The universal adapter of claim 2, wherein the adapter body has at least one conductive bar therein, which is integrated with one corresponding sleeve on the bottom cover, and a connection between the conductive bar and the corresponding sleeve is designed in such a way that the bottom cover is disintegrated from the adapter body to a predetermined distance without disassembling completely from the adapter body.

4. The universal adapter of claim 1, wherein the adapter body further comprises a sliding unit, which further comprises a sliding shaft and a rotating ring, the sliding shaft is integrated with the rotating ring to control lifting and dropping movements of the sliding shaft.

5. The universal adapter of claim 4, wherein male screw pattern is provided on outside of the sliding shaft, and female screw pattern is provided on inside of the rotating ring, the male screw pattern of the sliding shaft is screwed into the female screw pattern of the rotating ring to control the lifting and dropping movements of the sliding shaft.

6. The universal adapter of claim 1, wherein the rotating units of the power plug and every male connector are made from conductive materials
